(19) United States
(12) Patent Application Publication
(10) Pub. No.: US 2025/0198880 A1
(43) Pub. Date: Jun. 19, 2025

(54) MOTOR-MONITORING DEVICE

(71) Applicant: FANUC CORPORATION, Yamanashi (JP)

(72) Inventors: Kenji SHIMIZU, Yamanashi (JP); Makoto HAGA, Yamanashi (JP)

(73) Assignee: FANUC CORPORATION, Yamanashi (JP)

(21) Appl. No.: 18/844,257

(22) PCT Filed: Jun. 14, 2022
(86) PCT No.: PCT/JP2022/023765

§ 371 Date: Sep. 5, 2024

(51) Int. Cl. G01M 15/04; G01M 15/05

(52) U.S. Cl. CPC G01M 15/046; G01M 15/05

(57) ABSTRACT

A motor-monitoring device according to one embodiment of the present disclosure, which allows easy ascertaining of the status of a motor, comprises: a rotation speed acquisition unit that acquires the rotation speed of a motor operating according to an operating program; a history information storage unit that stores history information including the rotation speed at fixed time intervals; and a graph display unit that plots markers indicating the rotation speed in a graph region with one axis used for time and the other axis for rotation speed, the graph display unit changing the mode of the marker according to a prescribed index.

### TECHNICAL FIELD

The present invention relates to a motor monitoring device.

### BACKGROUND ART

For example, in motors such as spindle motors used in machine tools, where the load can significantly vary, there is a risk of overheating if a high load state persists and heat accumulates, Various time ratings can be set for such motors to ensure operation without overheating under specific conditions. For example, the time ratings specified in JIS-C4034-1 include continuous ratings enabling continuous operation, short-time ratings enabling operation for a certain period (load time) in a case where the operation starts at room temperature, and repetitive ratings enabling operation for a certain period (load time ratio) within a specified cycle time.

It has been proposed to estimate the time until a motor overheats while maintaining the current operational state (see, for example, Patent Document 1). Knowing the time until overheating can help determine whether the current machining operation can be completed.

### CITATION LIST

### Patent Document

Patent Document 1: Japanese Patent No. 5628994

### DISCLOSURE OF THE INVENTION

### Problems to be Solved by the Invention

However, estimating only the time until overheating does not allow for easily understanding the motor's operational safety and margin. Specifically, when the settings such as motor speed is adjusted to maximize the efficient machining while minimizing the margin for overheating, it is not easy to determine how much the set values should be increased or decreased. Therefore, a technique that allows for easily understanding the motor's state is desired.

### Means for Solving the Problems

A motor monitoring device according to one aspect of the present disclosure includes: a rotation number acquisition unit that acquires a rotation number of a motor operating in accordance with an operational program; a history information storage unit that stores history information including the rotation number at a regular time interval; and a graph display unit that plots a marker indicating the rotation number on a graph area, with one axis representing time and the other axis representing the rotation number, in which the graph display unit changes a mode of the marker in accordance with a predetermined index.

### Effects of the Invention

According to the present disclosure, the motor's state can be easily understood.

### BRIEF DESCRIPTION OF THE DRAWINGS

FIG. 1 is a block diagram illustrating the configuration of a machine tool including a motor monitoring device according to the first embodiment of the present disclosure;

FIG. 2 is a table illustrating the information stored by the history information storage unit of the motor monitoring device of FIG. 1; and

FIG. 3 is a diagram illustrating a screen displayed by the motor monitoring device of FIG. 1.

### PREFERRED MODE FOR CARRYING OUT THE INVENTION

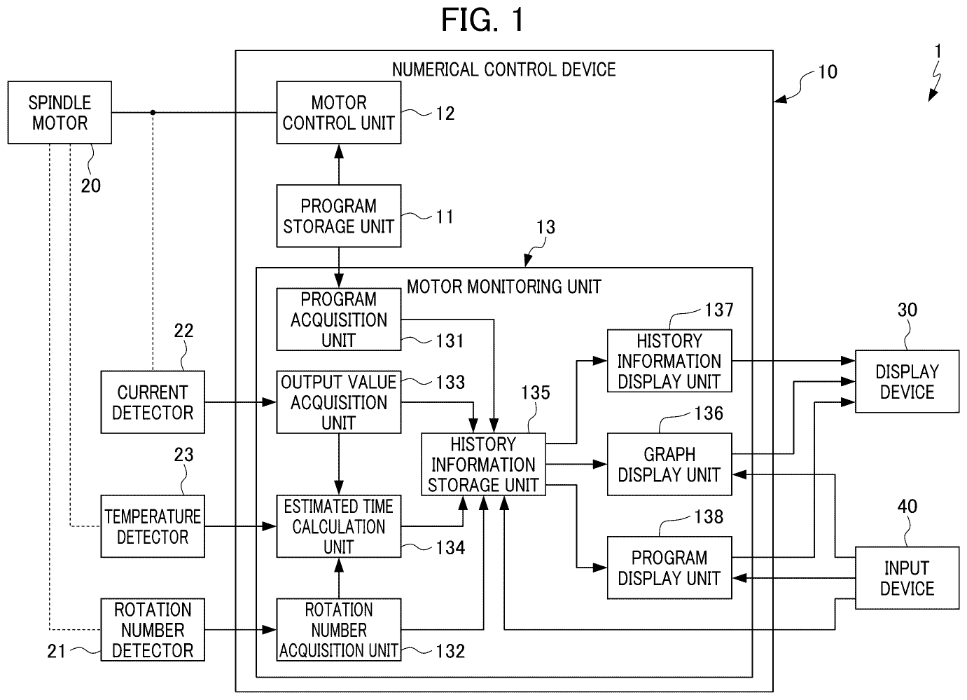

Hereinafter, embodiments of the present disclosure will be described with reference to the drawings. FIG. 1 is a block diagram illustrating the configuration of a machine tool 1 including a motor monitoring device according to the first embodiment of the present disclosure.

The machine tool 1 includes a numerical control device 10 as an embodiment of the motor monitoring device according to the present invention, a spindle motor 20, a rotation number detector 21 that detects the rotation number of the spindle motor 20, a current detector 22 that detects the current of the spindle motor 20, a temperature detector 23 that detects the winding temperature of the spindle motor 20, a display device 30 that displays a screen in accordance with the numerical control device 10, and an input device 40 used by the user to input into the numerical control device 10.

The numerical control device 10 controls the operation of the spindle motor 20 and other components in accordance with an operational program (referred to as a machining program in numerical control devices) to enable the machine tool 1 to perform predetermined machining on the workpiece. The numerical control device 10 includes a memory, a processor (CPU), input/output interfaces, etc., and can be implemented by one or more computer devices executing appropriate control programs. Components of the numerical control device 10 described below are categorized based on the functions of the numerical control device 10 and need not be distinctly separable in physical configuration and program configuration.

The spindle motor 20 is typically a motor that rotationally drives a cutting tool or workpiece. The spindle motor 20 operates in accordance with the operational program as described above, but the load can fluctuate independently of the rotation number, depending on the machining conditions. The rotation number detector 21, the current detector 22, and the temperature detector 23 can be composed of known sensors.

The display device 30 is a well-known display that displays in accordance with signals input from the numerical control device 10. The display device 30 may be integrated with the numerical control device 10. The input device 40 is a device used by the user to input information into the numerical control device 10 and may be composed of well-known components such as a keyboard or mouse. The input device 40 may also be integrated with the numerical control device 10. The input device 40 may also be integrated with the display device 30. Specifically, the display device 30 and the input device 40 may be a single input/output device such as a touch panel.

In the present embodiment, the numerical control device 10 includes: a program storage unit 11; a motor control unit 12 that controls the operation of motors that drive the drive axes of the machine tool 1 including the spindle motor 20; and a motor monitoring unit 13 that executes the functions of the motor monitoring device according to the present disclosure.

The program storage unit 11 stores operational programs executed by the machine tool 1. Each operational program includes a plurality of blocks that specify the unit operations of the machine tool 1. Each block includes one or more words formed by combinations of a plurality of characters (letters). Typically, each block is prefixed with a sequence number to identify the block.

The motor control unit 12 executes the machining procedures described in the operational program by controlling the spindle motor 20 and the motors of other drive axes of the machine tool 1 in accordance with the operational program. The configuration of the motor control unit 12 is the same as that of well-known numerical control devices, thus a detailed description is omitted.

The motor monitoring unit 13 includes a program acquisition unit 131, a rotation number acquisition unit 132, an output value acquisition unit 133, an estimated time calculation unit 134, a history information storage unit 135, a graph display unit 136, a history information display unit 137, and a program display unit 138.

The program acquisition unit 131 acquires an operational program from the program storage unit 11 that specifies the operation to be monitored for the spindle motor 20. In other words, the program acquisition unit 131 loads the target operational program into the working memory.

The rotation number acquisition unit 132 acquires the rotation number of the spindle motor 20 from the rotation number detector 21. The rotation number acquisition unit 132 may also acquire the rotation number of the spindle motor 20 via the motor control unit 12.

The output value acquisition unit 133 acquires the output values of the spindle motor 20, such as a current value, a power value, and a torque value. In the present embodiment, the output value acquisition unit 133 is configured to acquire the current value of the spindle motor 20 from the current detector 22 and to use the power value calculated from the current value as the output value. However, the output value acquisition unit 133 may be configured to use the detected value such as the current value directly as the output value. The output value acquisition unit 133 may also acquire the output value or the values necessary to calculate the output value from the motor control unit 12. The output value acquisition unit 133 may acquire two or more types of output values.

The estimated time calculation unit 134 calculates an estimated time to reach the overheating temperature in a case where the rotation number and the output value at that point in time is maintained by the spindle motor 20, based on the winding temperature of the spindle motor 20 acquired from the temperature detector 23 and the current value or output value acquired by the output value acquisition unit 133.

The history information storage unit 135 stores history information on the spindle motor 20 at regular intervals. The history information includes, as one element, the rotation number of the spindle motor 20, and as other elements, output values, winding temperature, load levels, other state information such as the estimated time to overheating of the spindle motor 20, program position information indicating the position of the corresponding command in the operational program, and modal information specifying the operation of the spindle motor 20. The program position information includes sequence numbers, line numbers, block numbers, etc. The modal information includes commands extracted from the operational program (not limited to those directly specifying the operation of the spindle motor 20, but also including commands that may affect the operation of the spindle motor 20, such as a command specifying a tool), and setting values of the numerical control device 10, such as the upper limit of acceleration. Load levels can be determined by the relationship between the rotation number and the output value on a graph with two axes. Specifically, the boundaries between the continuous rating, the time rating, and the maximum output in the graph can set the four load levels: the continuous operation level allowing for continuous operation, the short-time operation level allowing for intermittent operation within a predetermined period of time, the maximum load operation level allowing for exceptional operation for a very short period of time, and non-operational level where no operations are allowed even for a very short period of time.

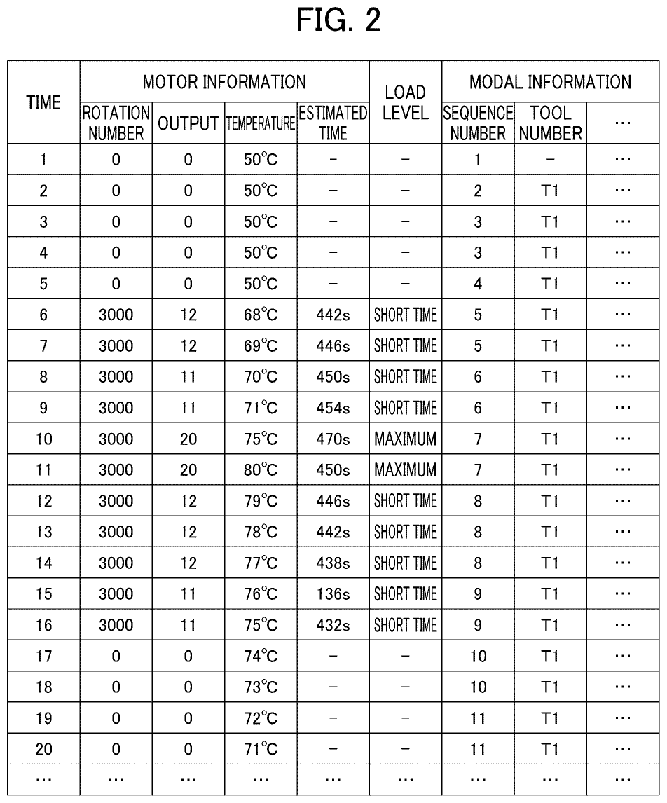

The time interval (unit time) for storing history information may be a predetermined fixed time or set in accordance with user instructions via the input device 40. Excessively short time intervals do not allow for confirming the correspondence with the operational program. Therefore, allowing the user to specify the time interval for storing history information ensures appropriate confirmation of the relationship between the operational state of the spindle motor 20 and the operational program. FIG. 2 illustrates the details of the history information stored by the history information storage unit 135. As is apparent from the drawing, the history information storage unit 135 can be configured to create a relational database using the acquisition time or serial number of the data as a unique key for the history information. The “-” in the drawing indicates that the calculation is not possible or the corresponding information does not exist.

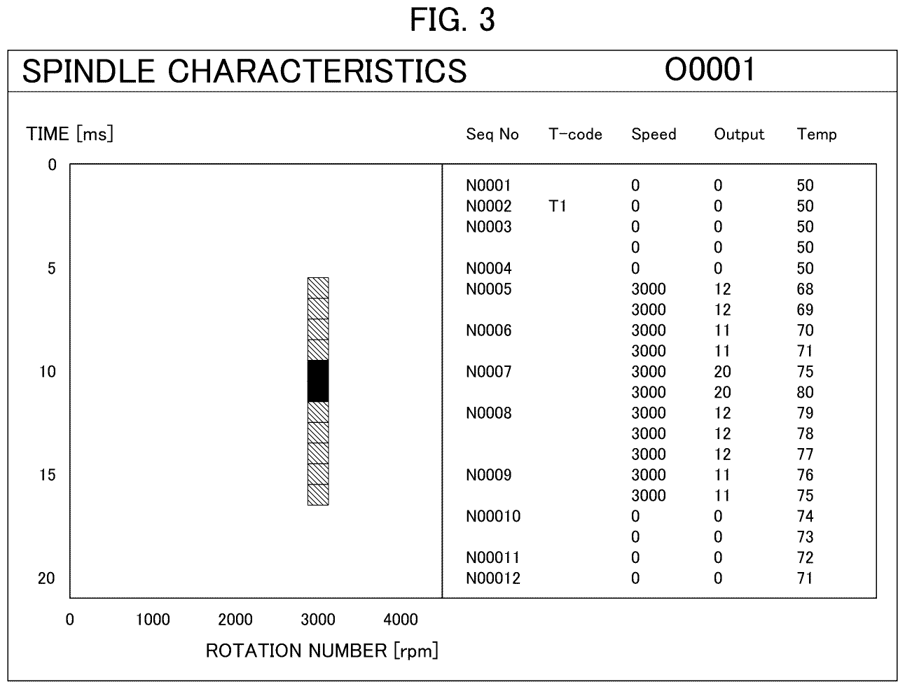

As illustrated on the left side of FIG. 3, the graph display unit 136 plots markers indicating the rotation numbers on a graph area, with one axis (vertical axis) representing the time and the other axis (horizontal axis) representing the rotation number. The graph display unit 136 changes the mode of the markers in accordance with a predetermined index. The indices for determining the mode of the markers can use the state information of the spindle motor 20, such as the aforementioned load levels, and the estimated time to reach the overheating temperature. The mode of the markers is changed in accordance with the state information such as load levels, whereby the user can easily understand the state of the spindle motor 20 at each time, for example, the margin of safety.

Changes to the mode of the markers by the graph display unit 136 can include, for example, changing colors in accordance with the value of the index (e.g., blue, yellow, red), changing the density or brightness in accordance with the value of the index, and changing the length or size of the markers in accordance with the value of the index. In other words, the graph display unit 136 preferably changes the display mode of the markers, based on a predetermined rule to make the magnitude of the index values identifiable. The graph display unit 136 may independently change the plurality of display modes of the markers, based on the plurality of indices to increase the amount of information presented to the user.

The graph display unit 136 may be configured to be capable of setting the time range of the graph area, based on the user-specified times, the completion times of acceleration or deceleration of the spindle motor 20, or the start and end times of the operational program. By appropriately setting the time range of the graph area, the user can easily understand the temporal changes in the state of the spindle motor 20.

The graph display unit 136 may allow the user to select the markers to be displayed, so as to serve as triggers for displaying the program by the program display unit 138. As illustrated, the graph display unit 136 may omit markers when the rotation number is zero or when the load is considered very small based on some index, making the graph easier to read.

As illustrated on the left side of FIG. 3, the history information display unit 137 displays at least part of the history information as text information aligned with the time axis of the graph display unit 136. In the illustrated example, the sequence number (Seq No) and the T code (T-Code) show only the updated information, in which no description means no changes from the previous time. The items displayed by the history information display unit 137 can be selectable by the user from the history information.

The history information display unit 137 may allow the user to select history information to be displayed for each unit time, so as to serve as a trigger for displaying the program by the program display unit 138.

The program display unit 138 displays a portion of the operational program corresponding to the markers selected by the user via the graph display unit 136 or corresponding to the history information selected by the user via the history information display unit 137, in an editable manner. In other words, the program display unit 138 provides an interface to partially rewrite the operational program stored in the program storage unit 11. The history information display unit 137 may display the program on the same screen as the graph display unit 136 and the history information display unit 137, or display the program on a larger area in a switched screen or popup display.

The numerical control device 10 according to the present embodiment includes the graph display unit 136 that plots markers indicating the rotation number of the spindle motor 20 on a graph area, with one axis representing the time and the other axis representing the rotation number, by changing the mode of the markers in accordance with a predetermined index. This allows for easily understanding the relationship between the change in the rotation number of the spindle motor 20 and the change in other states of the spindle motor 20.

Although the embodiments of the present disclosure have been described above, the present invention is not limited to the embodiments described above. The effects described in the above embodiments are merely examples of the preferred effects resulting from the present invention, and the effects of the present invention are not limited to those described in the above embodiments.

The motor monitoring device according to the present disclosure may be provided independently of the numerical control device that controls the machine tool, and may be used for monitoring the motors other than the spindle motor of the machine tool, such as the motor of a kneading machine. For example, the motor monitoring device according to the present disclosure may add the functions of the motor monitoring unit described in the above embodiments to a management computer that manages one or more numerical control devices, such as a control device for a kneading machine or a management computer that manages such a control device.

In the motor monitoring device according to the present disclosure, the history information display unit and the program display unit are optional configurations and may include a configuration to display history information or operational programs independently of the graph display unit.

### EXPLANATION OF REFERENCE NUMERALS

1: machine tool
10: numerical control device (motor monitoring device)
11: program storage unit
12: motor control unit
13: motor monitoring unit
131: program acquisition unit
132: rotation number acquisition unit
133: output value acquisition unit
134: estimated time calculation unit
135; history information storage unit
136: graph display unit
137: history information display unit
138: program display unit
20: spindle motor
21: rotation number detector
22: current detector
23: temperature detector
30: display device
40: input device

1. A motor monitoring device, comprising:
a rotation number acquisition unit that acquires a rotation number of a motor operating in accordance with an operational program;
a history information storage unit that stores history information including the rotation number at a regular time interval; and
a graph display unit that plots a marker indicating the rotation number on a graph area, with one axis representing time and the other axis representing the rotation number, wherein
the graph display unit changes a mode of the marker in accordance with a predetermined index.

2. The motor monitoring device according to claim 1, wherein the history information storage unit sets the time interval in accordance with a user instruction.

3. The motor monitoring device according to claim 1, further comprising:
an output value acquisition unit that acquires an output value of the motor, wherein
the graph display unit changes the mode of the marker in accordance with a load level determined based on the rotation number and the output value.

4. The motor monitoring device according to claim 1, wherein the graph display unit sets a time range of the graph area, based on a user-specified time, a completion time of acceleration or deceleration of the motor, or start and end times of the operational program.

5. The motor monitoring device according to claim 1, further comprising:
a history information display unit that displays at least part of the history information as text information aligned with a time axis of the graph display unit.

6. The motor monitoring device according to claim 5, further comprising:
an estimated time calculation unit that calculates, as one element of the history information, an estimated time to reach an overheating temperature in a case where an operational state at that point in time is maintained by the motor.

7. The motor monitoring device according to claim 5, wherein
the history information includes program position information that identifies a position in the operational program, and
the motor monitoring device further comprises a program display unit that displays a portion of the operational program corresponding to the marker selected by a user via the graph display unit or corresponding to the history information selected by the user via the history information display unit, in an editable manner.
